(19) United States
(12) Patent Application Publication
(10) Pub. No.: US 2025/0384067 A1
(43) Pub. Date: Dec. 18, 2025

(54) MULTI-TENANT GENERATIVE ARTIFICIAL INTELLIGENCE SYSTEM

(71) Applicant: Salesforce, Inc., San Francisco, CA (US)

(72) Inventors: Jose Lejin P J, Bangalore (IN); Premenjit Das, Bangalore (IN); Ramanjaneyulu Y Talla, Bangalore (IN); Tanmay Singh, Bangalore (IN); Prabhat Singh, San Francisco, CA (US)

(21) Appl. No.: 18/743,828

(22) Filed: Jun. 14, 2024

(51) Int. Cl. G06F 16/33; G06F 16/332; G06F 16/338

(52) U.S. Cl. CPC G06F 16/3344; G06F 16/3322; G06F 16/338

(57) ABSTRACT

A system may receive a configuration associated with a tenant of a multi-tenant generative artificial intelligence (AI) system and tenant-specific training data, where the configuration includes a first indication of a first communication channel over which a tenant-specific conversational agent is to communicate with users and where the tenant-specific training data includes context information associated with the tenant that is expressed in natural language. The system may determine an intent of a query received from the tenant based at least in part on an analysis of the query. The system may transmit the query to a first generative AI model of a plurality of generative AI models, wherein the first generative AI model is selected based at least in part on the determined intent. The system may transmit, to the tenant over the first communication channel, a response to the query generated by the first generative AI model.

### FIELD OF TECHNOLOGY

The present disclosure relates generally to database systems and data processing, and more specifically to multi-tenant generative artificial intelligence system.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some examples, a cloud platform may employ generative artificial intelligence (AI) systems. However, such approaches may be improved.

### BRIEF DESCRIPTION OF THE DRAWINGS

FIG. 1 illustrates an example of a data processing at a generative artificial intelligence (AI) system that supports multi-tenant generative artificial intelligence system in accordance with examples as disclosed herein.

FIG. 2 shows an example of a system that supports multi-tenant generative artificial intelligence system in accordance with examples as disclosed herein.

FIG. 3 shows an example of a system that supports multi-tenant generative artificial intelligence system in accordance with examples as disclosed herein.

FIG. 4 shows an example of a process flow that supports multi-tenant generative artificial intelligence system in accordance with examples as disclosed herein.

FIG. 5 shows a block diagram of an apparatus that supports multi-tenant generative artificial intelligence system in accordance with examples as disclosed herein.

FIG. 6 shows a block diagram of a multi-tenant operations manager that supports multi-tenant generative artificial intelligence system in accordance with examples as disclosed herein.

FIG. 7 shows a diagram of a system including a device that supports multi-tenant generative artificial intelligence system in accordance with examples as disclosed herein.

FIG. 8 shows a flowchart illustrating methods that support multi-tenant generative artificial intelligence system in accordance with examples as disclosed herein.

### DETAILED DESCRIPTION

Bot services for responding to queries for specific areas (e.g., security) have been developed (e.g., systems have been developed to handle customer queries in security scenarios). In some cases, other areas (e.g., other domains or operations areas) may also benefit from such query handling and response. However, handling such queries from multiple customers with different scenarios and problems arising becomes difficult using existing systems that are tailored to more specific customers, use cases, or domains.

The techniques described here aim to provide a unified solution for serving multiple tenants/customers with query handling and response capabilities (e.g., through a communication service, such as Slack) while providing accurate, relevant results across these multiple tenants. Such an approach allows any operational team to leverage its capabilities with customized settings and AI training data tailored to their specific considerations. For example, such a system may ingest customer-specified configurations and customer-specific training data to train generative AI models that are used to aid in responding to customer queries that are handled through the communications platform. The system may then configure the system according to the configuration and train the generative AI models using the customer-specific training data. In at least these ways, the system is capable of responding to requests and performing actions that are specified by the tenants and that are based on the tenant-specific information provided in the training data in different operational domains. The system may accommodate different tenants while providing accurate and relevant information in response to queries. In some examples, the system may provide for integration with different communications platforms through which queries are received and responses are transmitted. In some examples, the system may further provide graphical visualizations as part of query responses that may be customized and configured for different tenants, centralized management and monitoring, and convenient access to functionalities and monitoring tools for the tenants.

Aspects of the disclosure are initially described in the context of an environment supporting an on-demand database service. Aspects of the disclosure are then described with reference to a system, a system, and a process flow. Aspects of the disclosure are further illustrated by and described with reference to apparatus diagrams, system diagrams, and flowcharts that relate to multi-tenant generative artificial intelligence system.

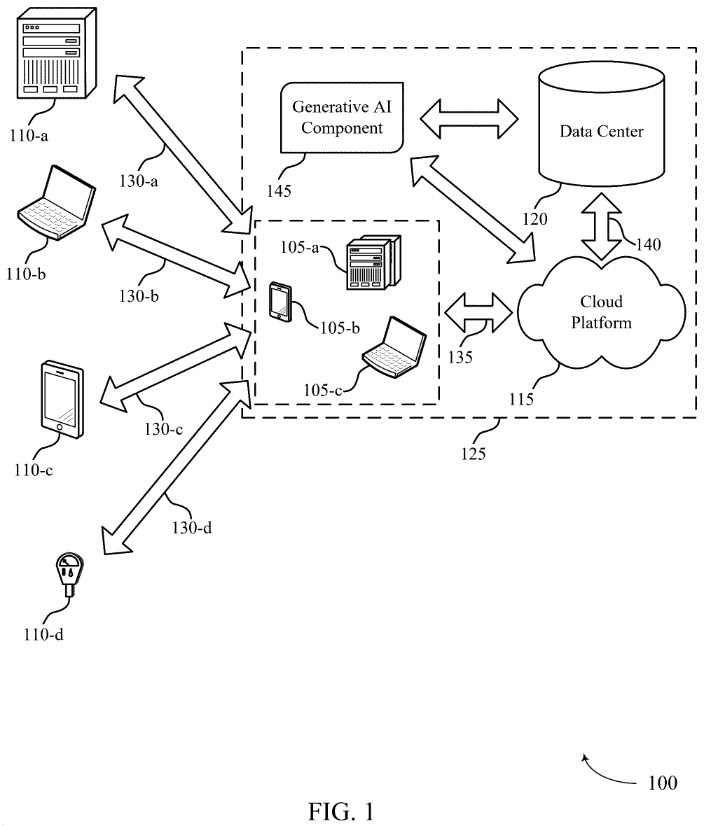

FIG. 1 illustrates an example of a system 100 for cloud computing that supports multi-tenant generative artificial intelligence system in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

Additionally, or alternatively, the system 100 may support the use of a large language model (generative AI model), such as the generative AI component 145. In some examples, a generative AI component 145 may also be referred to as any of an artificial intelligence (AI), a generative AI (GAI), a GAI model, a large language model (LLM). The generative AI component 145 may be a model that is trained on a corpus of input data, which may include text, images, video, audio, structured data, or any combination thereof. Such data may represent general-purpose data, domain-specific data, or any combination thereof. Further, a generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may transmit a prompt to the generative AI component 145 that includes the query (or information included therein) and receive the generated output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located outside of the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

Multiple cloud clients 105 may operate in associated with the cloud platform 115. Each of the multiple cloud clients 105 may provide a configuration and training data specific to the cloud client 105 that may be used to train and operate the generative AI component 145, which may include multiple generative AI models, other processing models, or any combination thereof. The cloud platform 115 may determine an intent of a query provided by the cloud client 105 (e.g., through a tenant-specific conversation bot operating on a communication channel of a communication service) and may determine a processing flow based on the intent of the query. Such a processing flow may indicate or include one or more processing steps by one or more of the elements of the generative AI component 145. The generative AI component 145 may process the query and perform one or more operations based on the query and provide a response to the cloud platform 115. The cloud platform 115 may perform one or more actions associated with one or more services (e.g., that are internal or external to the cloud platform 115 or the subsystem 125). The cloud platform 115 may transmit a response to the cloud client 105 based on the one or more operations performed by the generative AI component 145 (e.g., the response), the operations performed in association with the services, or both.

Generative AI solutions have been employed that utilized generative AI models to answer questions, perform operations, or otherwise produce output. However, some such approaches do not account for multiple tenants using the same system and further do not account for tenant-specific considerations. For example, some such approaches, while specifically trained and configured for use with a single tenant, such a system may not handle multiple tenants that may have different considerations between them.

The techniques described herein include techniques for adaptively providing generative AI services to different tenants based on tenant-specific considerations. For example, a system may receive a tenant-specific configuration, tenant-specific training data, tenant-specific context information, or any combination thereof, to configure generative AI models, other processing elements, one or more parameters of the system, or any combination thereof, to provide for accurate, relevant results from the generative AI models or other processing elements. Such a system may include customization and tuning of the generative AI models, adaptation of processing flows, and other elements on a per-tenant basis, thereby allowing tenant-specific customization and handling of such customization for multiple tenants, even many such tenants.

For example, a tenant may transmit a tenant-specific configuration and tenant-specific training data (e.g., which may include tenant-specific context information), to the system. The system may train one or more generative AI models based on the tenant-specific training data and the system may further configure one or more parameters of the system based on the tenant-specific configuration, including configuration of a tenant-specific communication bot that operates over a communication channel of a communication application or service. The tenant may then communicate with the communication bot over the communication channel to request operation of the one or more generative AI models or processing elements to produce responses, perform other actions (e.g., with connected services), or produce other output of the system, which may be transmitted to the tenant over the tenant-specific communication channel. Each tenant may perform such operations, and the operations performed by the system may be different (e.g., generative AI model training, configuration of the system, configuration of connected services, or any other techniques or operations described herein) and specific to the tenant.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

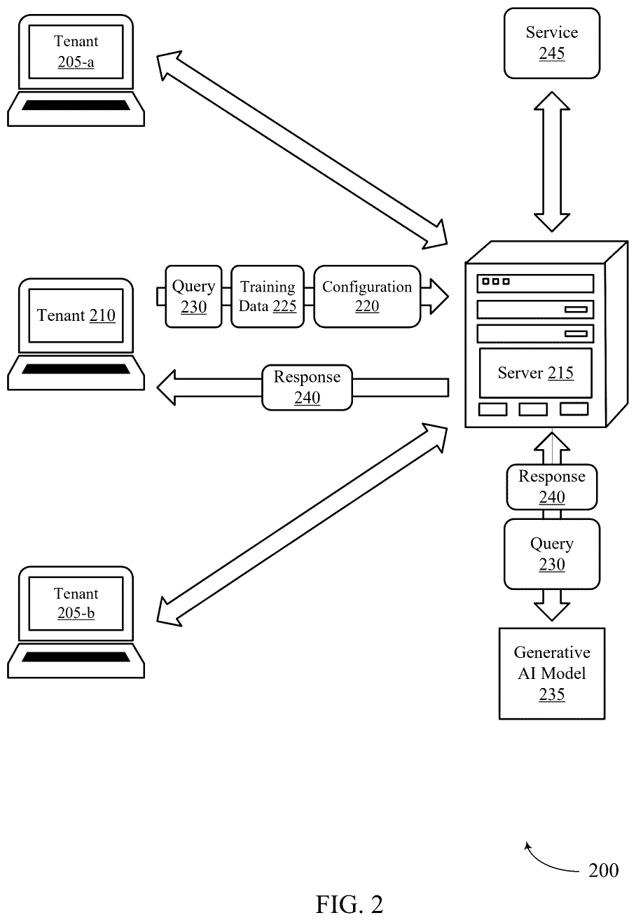

FIG. 2 shows an example of a system 200 that supports multi-tenant generative artificial intelligence system in accordance with examples as disclosed herein. The system 200 may include a tenant 210, one or more other tenants 205, and a server 215. The server 215 may be a single device or may represent one or more devices of a cloud system or service.

Some monolithic generative AI systems focus on the efficient management of customer inquiries within a narrow field or topic, such as those related to support for a particular service. However, such systems are limited and some tenants may desire efficient query resolution within various operational domains and operational areas. However, the creation of separate bot services for each such domain or area may not be practical or technically feasible.

Thus, in some examples, the system 200 (and other techniques described herein) may reduce or eliminate the use of individual bot services for each operation domain or area by providing a unified solution. For example, the system 200 may operate on a tenant service model, permitting any operational team to utilize its capabilities with settings and AI training data customized to their specific needs. Such techniques allow for smooth integration, allowing multiple communication bots to communicate with tenants over communication channels to utilize the functionalities of the system 200.

By providing a unified solution with tenant-specific customizable settings and AI training data, the system 200 (and other techniques described herein) simplifies query resolution processes and improves operational efficiency universally. Through smooth integration and centralized management, the system 200 enables different operations to deliver outstanding support experiences while promoting business success.

For example, the system 200 may provide for the tenant 210 to communicate with the server 215 to transmit the configuration 220 and the training data 225. The configuration 220 may include information associated with the tenant that may be included for tenant-specific scenarios, processing flows, service options, moratorium information or other information associated with operation of the system 200 for the tenant 210 (e.g., any of the information described herein). Further the training data 225 may include information that is specific to the tenant 210 and operations that the tenant 210 may desire to perform using the system 200. For example, the training data 225 may include context information, procedures, service information (e.g., identifiers or capabilities), onboarding information, processing flows, formats, or other information associated with the tenant 210.

Using the configuration 220 and the training data 225 (among other information), the server 215 may configure one or more aspects of the system 200 to provide for tenant-specific processing using the generative AI model 235. For example, the server 215 may use the training data 225 to train one or more generative AI models (e.g., the generative AI model 235) so that the one or more generative AI models may produce responses using the information included in the training data, thereby providing the tenant 210 with tenant-specific output.

In some examples, the tenant 210 may transmit the query 230 to the server 215. The server 215 may determine an intent of the query 230 based on the configuration 220, the training data 225, processing using the generative AI model 235, one or more other techniques described herein, or any combination thereof. The server 215 may transmit the query 230 (and any modifications made to the query 230, such as those based on the determined intent) to the generative AI model 235 for processing. The generative AI model 235 may process the query 230 (and, in some examples, one or more portions of the configuration 220, the training data 225, or any combination thereof) to produce the response 240. The response 240 may be received by the server 215 which will be processed and presented to the tenant 210. For example, the server 215 may modify one or more aspects of the response 240 (e.g., content, formatting, or other aspects) based on one or more parameters or other information included in the configuration 220.

In some examples, in response to determining the intent of the query 230, receiving or processing the response 240, or any combination thereof, the server 215 may communicate with one or more services, such as the service 245, to perform one or more actions indicated in the query 230 or the response 240. For example, the generative AI model 235 may process the query 230 and indicate in the response 240 that the server 215 is to communicate with the service 245 and perform one or more actions, such as data retrieval or processing at the service 245. In response, the server 215 may perform the one or more actions and may include information retrieved or generated as a result of the one or more actions or an indication of the one or more actions in the response 240.

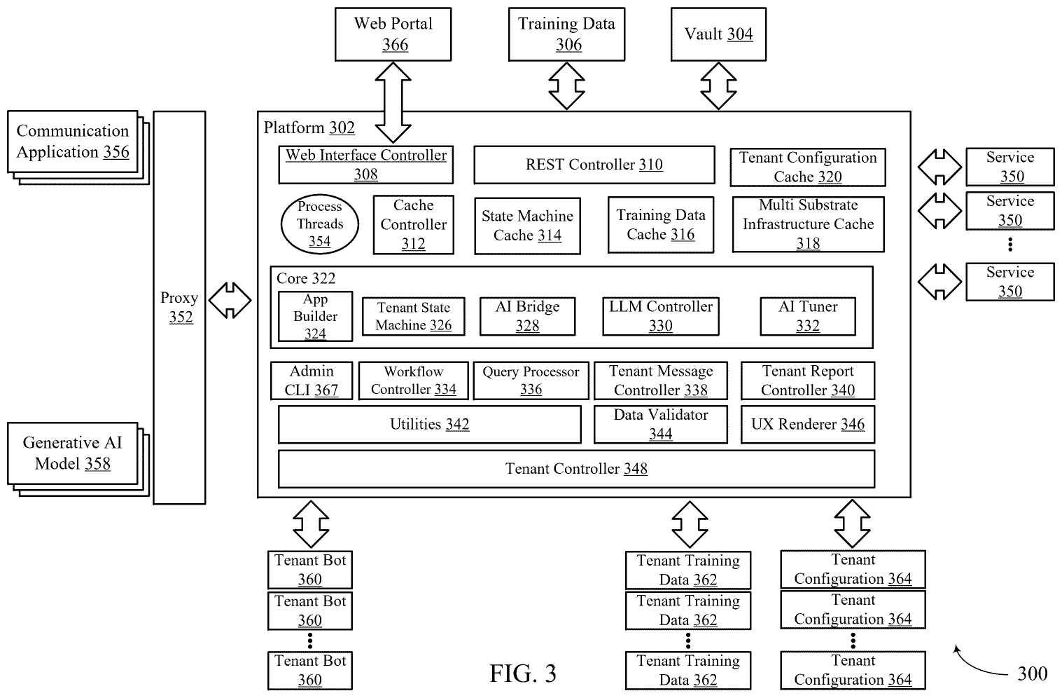

FIG. 3 shows an example of a system 300 that supports multi-tenant generative artificial intelligence system in accordance with examples as disclosed herein. Though some elements are described as performing some functions, other elements of the system 300 may perform such functions (e.g., in addition to the described elements or as an alternative to the described elements). The examples provided herein are not to be interpreted as limiting, and any element described herein (or any combination of elements) may perform any operation described herein.

In some examples, the platform 302 may include elements that may perform different functions to provide tenant-specific operation. The platform 302 may be hosted on a single device, on multiple devices, on a system, or a platform, such as a cloud platform (e.g., an internal cloud platform, a third-party cloud platform, or other type of cloud platform).

The system 300 offers a plug-and-play operational support system that is generic for any operations and includes a set of configurations. It is a multi-tenant based platform that provides a comprehensive end-to-end solution for zero-touch triaging of any operation-related queries in a computing infrastructure, which is spread across multiple substrates (e.g., AWS Cloud, Azure, GCP, Ali Cloud, and others).

In some examples, the platform may include the core 322, which may include one or more services that manage aspects of the platform 302. The platform may include a tenant controller 348, that may coordinate communications or information associated with the various tenants on a per-tenant basis, including communications involving the tenant bots 360, the tenant training data 362, the tenant configuration 364, other tenant-specific information, or any combination thereof.

In some examples, the system 300 allows for plug-and-play operations through the use of the tenant configurations 364. Such configurations 364 may be or may include a JavaScript Object Notation (JSON) configurations, other structured data, or non-structured data. Additionally, or alternatively, the tenant training data 362 may also be provided to the platform 302, which may include natural language training data. In some examples, one or more of the tenant configuration 364 and the tenant training data 362 may be updated by the tenant (e.g., in one or more tenant-specific documents that may be accessed by the tenant, either through the tenant bot 360 or through the web portal 366, which may be used for one or more management functions by the tenant.

In some examples, the system 300 may include a tenant-based bot bridge for asynchronous handling of tenant-specific dependent services data to assist with customer queries. Such a bot bridge may be included in or associated with the tenant controller 348.

In some examples, the system 300 also fully automated on-call coordination for tenants with options for condition configurations regarding on-call rotation, holidays, moratorium periods, or any combination thereof. For example, the tenant configuration 364 may indicate such information regarding on-call rotation, holidays, moratorium periods, or any combination thereof, and the system 300 may store such information (e.g., along with any other information included in the tenant configuration 364) in the tenant configuration cache 320. In some examples, the tenant configuration cache 320 may communicate with one or more other storage locations (e.g., persistent storage locations) to transmit or receive tenant configurations 364 and coordinate storage and management of tenant configurations 364.

In some examples, the system 300 may generate graphical visualization diagrams based on queries from tenants, with flexibility for tenant-specific configuration for the type of diagrams and their representation. In some examples, such operations may be generated or provided via the UX renderer 346.

In some examples, the system 300 may include tenant-specific on-call reporting and status dashboards. For example, such reporting and dashboards may be provided through the web interface controller 308 to the web portal 366 or via the tenant bot 360. In some examples, such reporting may be managed on a per-tenant basis by the tenant report controller 340.

In some examples, the system may handle received input (e.g., through the tenant bot 360 and the tenant controller 348), such as queries that are to be processed by the generative AI models 358. In some examples, the system 300 is a multi-tenant based user intent query handling platform that automatically interprets intent (e.g., of queries) on a per-tenant basis (e.g., through the use of the query processor 336 or one or more other elements of the system 300). For example, the tenant controller 348 may handle reception of queries. In some examples, the system 300 may provide visibility into the tenant's backend infrastructure for tenants and users. In some examples, the system 300 may handle user intent based on multiple generative AI models 358 based on tuned parameters (parameters of the generative AI models 358 or other processing elements that may be tuned by the AI tuner 332 based on the tenant training data 362, the tenant configuration 364, or both.

In some examples, the system 300 includes the AI bridge 328 for interfacing with any generative AI model (or other processing model), determining intents of queries, tuning intents or queries, or any combination thereof, as desired (e.g., through the use of the AI tuner 332). In some examples, a retrieval augmented generation (RAG) model, in-context learning (ICL) approaches, or both, may be employed to fit multi-substrate data and customer-specific training with an option for prioritizing one or more data sets.

In some examples, the system 300 may loop back automatically from previous communications to train the generative AI models 358 for learning (e.g., with preprocessing and customization filters). In some examples, the system 300 may map user intent expressed in queries or in other communications automatically based on the tenant training data 362, the tenant configuration 364, or both, including auto-detection of tenant-related backend system states in the query (e.g., through the use of the tenant state machine 326).

In some examples, the system 300 may improve the automation of query responses based on communication history (e.g., communications through the communication channel over the communications application 356, optionally made through the tenant bot 360). For example, the system 300 may offer configurable conversation and workflow modes, either of which may be applied for responding to tenant queries. In some examples, such workflows or processing flows may be customized (e.g., including UX forms and response formats, which may be performed through the use of the UX renderer 346).

In some examples, the system 300 may allow for tenant-specific processing flows (e.g., “chain of thoughts” processes) that may be formed by connecting the system 300 to multiple generative AI models 358 or other processing elements that may be trained or configured on a per-tenant basis (e.g., through the use of the AI bridge 328, the LLM controller 330, or the AI tuner 332). In some examples, the system 300 may correct or suggest user queries automatically based on tenant-specific data (e.g., the tenant training data 362 or the tenant configuration 364).

In some examples, the system 300 may perform tenant-specific sentimental analysis of one or more users associated with the tenant (e.g., based on queries and responses) which may be used as a basis for improvements for further responses (e.g., through an AI analysis). The sentimental analysis can be tuned as per configuration parameters (e.g., the tenant configuration 364).

In some examples, the system 300 provides for tenant customization (e.g., through the web portal 366, the web interface controller 308, the tenant configuration cache 320) for any aspect of the system 300, including response format and structure, to one or more users associated with the tenant. For example, per-tenant customization of interaction with internal or external services (e.g., the services 350) may be employed. Such a system 300 provides an innovative technique for tenant collaboration by contacting and operating using multiple services spread (optionally, across multiple tenants) for responding to user queries.

In some examples, the system 300 provides for management of workflows or processing flows (e.g., through multiple generative AI models 358) enabling configuration across multiple substrates (e.g., where such flows are managed through the use of the workflow controller 334). For example, the system 300 may receive tenant-specific generic queries which may involve the use of multiple services 350 associated with the tenant that may be spread across multiple substrates by automatically understanding user utterances, mapping intents and information in the queries to the services 350, modifying queries or determined intents (e.g., based on the tenant-specific information, including the tenant training data 362 and the tenant configuration 364) and determining a processing flow for processing of the query to produce a response to the query that is to be presented to the tenant.

In some examples, the system 300 may provide for triaging and troubleshooting of customization options associated with requested actions and tenant inputs as desired (e.g., through the use of the data validator 344). In some examples, the system 300 may perform an analysis across one or more services 350 spread across multi substrates for user queries (e.g., to determine one or more issues indicated by the tenant or detected by the system 300) and may provide an asynchronous response to the tenant. In some examples, the system 300 may provide an indication of an issue, a result of the analysis, and a recommendation for resolving the issue.

In some examples, the system 300 allows for cross-tenant collaboration with the option for a tenant to contact other tenant bots 360 associated with other tenants to handle one or more aspects of a query. In some examples, such forwarding or arrangement of queries between the tenant bots 360 may be handled by the tenant controller 348, the query processor 336, or one or more other elements. By using this flexible structure, the system 300 may handle any quantity of tenants and respective users, at least by automatically scaling and ensuring tenant data security and operation isolation.

In some examples, the system 300 may provide a centralized dashboard and monitoring of all tenants at a single point, such as through the use of the admin command line interface (CLI) 367, the web portal 366, or one or more other interfaces.

In some examples, representational state transfer (REST) operations may be managed by the REST controller 310. In some examples, the web portal 366 may operate in conjunction with the REST controller 310 to perform one or more operations, including to retrieve or transmit data (e.g., via get, operations, post operations, or other operations).

In some examples, the process threads 354 may include threads that are separated and secured on a per-tenant basis, such that process threads 354 of one tenant do not mingle with threads of another tenant. The process threads 354 may be associated with any of the operations performed by the system 300 for a tenant. Further, in some examples, all of the data or processing associated with a first tenant may be separated and may not be mixed or mingled with data or processing associated with other tenants.

In some examples, the cache controller 312 may manage one or more caches for storing information for the system 300, including the state machine cache 314, the training data cache 316, the multi substrate infrastructure cache 318, the tenant configuration cache 320, one or more other caches or storages for storing information (e.g., tenant-specific information), or any combination thereof. In some examples, the state machine cache 314 may store tenant-specific information associated with different states of the system 300. In some examples, the training data cache 316 may store the tenant training data 362. In some examples, the multi substrate infrastructure cache 318 may store tenant-specific information associated with the various services 350 that the tenant may employ and any associated substrates upon which the services 350 may operate.

In some examples, the app builder 324 may aid in building processing flows, applications, or other processing elements that may be used by the system 300 to respond to queries from tenants.

In some examples, the tenant state machine 326 aids in managing states of the system 300 or components thereof on a per-tenant basis, such that states are not shared between different tenants. In some examples, such information about different states of the system 300 or components thereof may be stored in the state machine cache 314.

In some examples, the tenant message controller 338 may manage messaging from the system 300 to the tenant. For example, the tenant message controller 338 may manage transmission of alerts or other messaging to the tenant associated with operation of the system 300.

In some examples, the utilities 342 may include one or more utilities that are tenant-specific or tenant-agnostic, including tenant utilities, communication application utilities, generative AI model utilities, internal service utilities, external service utilities, one or more other utilities, or any combination thereof, that may be used to modify parameters, change operation, or otherwise interact with various elements of the system 300.

In some examples, communications or information passed between the platform 302, the communications application 356, the generative AI models 358, or any combination thereof, may be made through the use of the proxy 352.

In some examples, the training data 306 may include general training data or tenant-agnostic training data that may be used to train the generative AI models 358 using a more general scope or for groups of tenants.

In some examples, the vault 304 may be used to securely store credentials associated with the communications applications 356, one or more tenant bots 360, one or more services 350, one or more other elements of the system 300, or any combination thereof. In some examples, to perform one or more operations described herein, the system 300 may retrieve or store credentials from or in the vault 304.

In some examples, the system 300 may engage in one or more onboarding operations to establish provision of services to a tenant. For example, in situations in which a new tenant wishes to onboard to use the system 300, the tenant may post a request in a communication channel of the communications application 356. In some examples, one or more documents may be provided to the tenant that contain placeholders for configuration and training data (e.g., the tenant training data 362 and the tenant configuration 364). In some examples, a new tenant configuration 364 for onboarding may include one or more specifications including the communications channels of the generative AI models 358 the tenant bot 360 is to operate, on-call engineer details, schedule information, tenant administrators, other information associated with operation of the system 300, or any combination thereof.

In response to the tenant providing the configuration and training data, an integration and deployment process may begin, which may involve setting up the tenant bot 360 in the specified operational channels and configuring it according to the provided settings. The tenant training data 362 may be used to train the AI model, promoting proficiency in understanding and responding to queries within the tenant's operational domain.

In some examples, the system 300 may provide for responses to user queries related to flow checks (e.g., connectivity, connections, etc.) and generate visualization flow diagrams. The graphical diagrams format and flow type can be easily configured on a per-tenant basis, optionally including automatic testing of connectivity patterns for validity before rendering the response.

In some examples, the system 300 may provide for effective management and monitoring, centralized dashboards may be provided. Such dashboards may provide insights into bot performance, query resolution metrics, and system health across all operational domains. Administrators can easily configure settings, manage tenant access, and monitor bot activity through intuitive dashboards. Real-time alerts and notifications enable prompt action in response to any issues or anomalies, ensuring uninterrupted service delivery and exceptional tenant experience.

In some examples, the system 300 may include the web portal 366, which may allow a range of functionalities, monitoring tools, and REST APIs (e.g., configured or managed by the REST controller 310) to be accessible to all tenants. Through the web portal 366, tenants or users may submit queries, view dashboard overviews, manage configurations, manage training data, monitor and set alerts, report and analyze, and access documentation offering guidance on various aspects of platform usage.

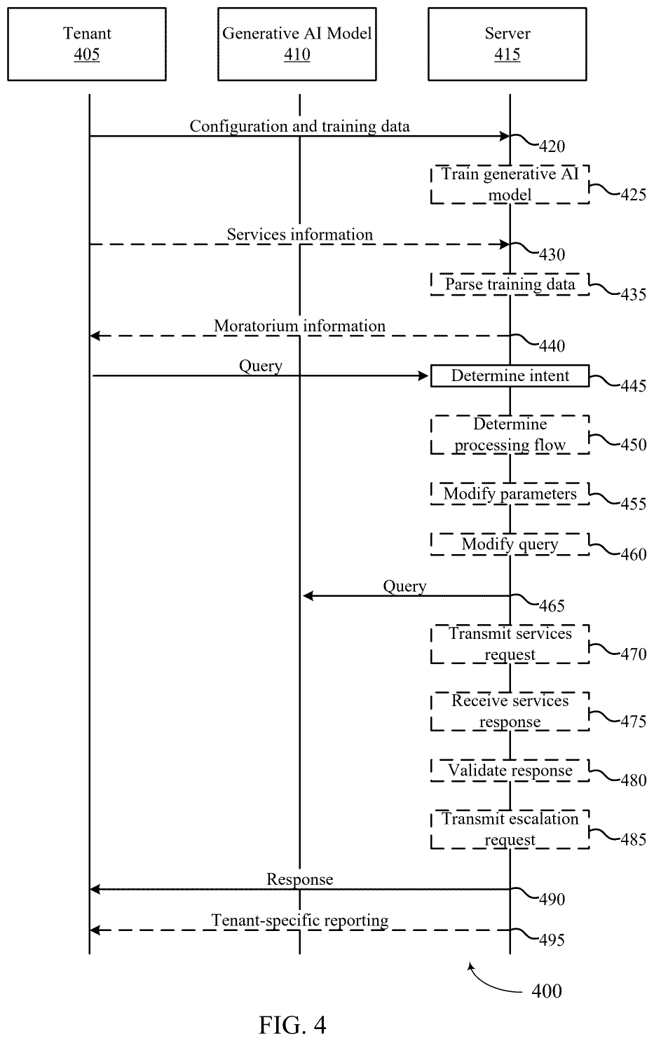

FIG. 4 shows an example of a process flow 400 that supports multi-tenant generative artificial intelligence system in accordance with examples as disclosed herein. The process flow 400 may implement various aspects of the present disclosure described herein. The elements described in the process flow 400 (e.g., server 415, generative AI model 410, and tenant 405) may be examples of similarly named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

At 420, the server 415 may receive a configuration associated with a tenant 405 of the multi-tenant generative AI system and tenant-specific training data associated with the tenant 405 and the configuration includes a first indication of a first communication channel over which a tenant-specific conversational agent is to communicate with users associated with the tenant 405 and wherein the tenant-specific training data includes context information associated with the tenant 405 that is expressed in natural language. In some examples, the configuration further includes a second indication of a second communication channel associated with escalation operations and a third indication of moratorium information associated with operation of the tenant-specific conversational agent.

At 425, the server 415 may train the first generative AI model based on the tenant- specific training data, an analysis of one or more communications with the tenant-specific conversational agent, one or more previous responses generated by the first generative AI model, or any combination thereof.

At 430, the server 415 may receive tenant-specific services data associated with the tenant 405.

At 435, the server 415 may parse the tenant-specific training data to determine the context information, one or more actions that are available to the tenant 405, one or more conditions associated with the one or more actions, one or more procedures associated with the tenant 405, one or more services associated with the tenant 405, or any combination thereof.

At 440, the server 415 may transmit, to the tenant 405 over the first communication channel and based on satisfaction of a moratorium condition indicated in the moratorium information, an indication of a moratorium period and the indication of the moratorium period may include a length of the moratorium period, one or more indications of prioritized operations associated with the moratorium period, or any combination thereof. Additionally, or alternatively, the server 415 may possess moratorium information (e.g., standard or default moratorium information that follows regular schedules, events, or other information, which optionally may be information associated with a cloud platform or other system). Such moratorium information may be transmitted to the tenant 405. Additionally, or alternatively, the tenant 405 may transmit customized moratorium information that may be associated with the tenant 405 or may be applied to operations associated with the tenant 405 (e.g., automated responses may be transmitted in response to queries indicating a moratorium or one or more available actions in accordance with the customized moratorium information. For example, in some examples, the tenant 405 may indicate a time period for a moratorium. During such a moratorium, requests received during the indicated time period may be processed and responses may be transmitted (e.g., indicating the moratorium period or one or more corresponding actions that may be available during the moratorium period).

At 445, the server 415 may determine an intent of a query received from the tenant 405 based on an analysis of the query. in some examples, determining the intent of the query is based on the tenant-specific training data.

At 450, the server 415 may determine a tenant-specific processing flow that is associated with the tenant 405 and that may include operations associated with the first generative AI model, one or more additional generative AI models of the plurality of generative AI models, or any combination thereof.

At 455, the server 415 may modify one or more parameters of one or more elements of the multi-tenant 405 generative AI system based on the tenant-specific services data. Additionally, or alternatively, the server 415 may modify one or more parameters associated with the first generative AI model based on the determined intent.

At 460, the server 415 may transmit, to the tenant 405 over the first communication channel, an indication of a suggested modification to the query based on the analysis of the query, the tenant-specific training data, or both. In some examples, the server 415 may modify the query based on reception of a response to the indication of the suggested modification to the query.

At 465, the server 415 may transmit the query to a first generative AI model of a plurality of generative AI models and the first generative AI model is selected based on the determined intent. In some examples, transmission of the query to the first generative AI model is based on the tenant-specific processing flow.

At 470, the server 415 may transmit, to a service associated with the multi-tenant 405 generative AI system, a request to perform an action indicated in the response to the query. In some examples, the server 415 may request one or more credentials from a credential repository based on the response to the query. In some examples, the request to perform the action may include an indication of the one or more credentials. In some examples, the server 415 may select the service based on the configuration, the tenant-specific training data, or both. In some examples, the server 415 may detect a state of the service based on the configuration, the tenant-specific training data, or both and the transmission of the request to perform the action is based on the detection of the state.

At 475, the server 415 may receive, from the service, a first indication that the action has been performed.

At 480, the server 415 may validate the response to the query via a retrieval augmented generation (RAG) service, an in-context learning (ICL) service, or both, the validation being based on the configuration, the tenant-specific training data, or both.

At 485, the server 415 may transmit an escalation request via the second communication channel based on an escalation indication comprised in the response to the query.

At 490, the server 415 may transmit, to the tenant 405 over the first communication channel, a response to the query generated by the first generative AI model. In some examples, the server 415 may transmit, to the tenant 405 over the first communication channel, a second indication that the action has been performed. In some examples, the server 415 may present, via a user interface, a graphical representation of information indicated in the response to the query and the graphical representation is presented in a tenant-specific format determined based on the query, the configuration, the tenant-specific training data, or any combination thereof, and wherein the tenant-specific format is specified in the configuration. In some examples, the graphical representation may include one or more graphical visualizations of any operations, data, or both, associated with operation of the multi-tenant generative AI system.

At 495, the server 415 may transmit, to the tenant 405 over the first communication channel, tenant-specific reporting associated with the tenant 405 and the multi-tenant generative AI system.

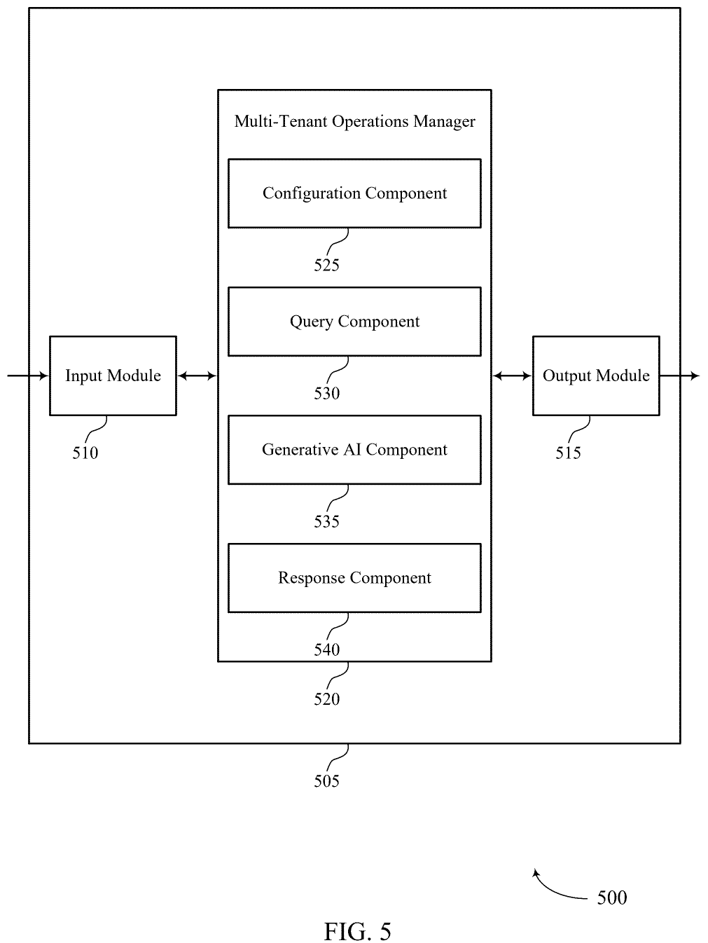

FIG. 5 shows a block diagram 500 of a device 505 that supports multi-tenant generative artificial intelligence system in accordance with examples as disclosed herein. The device 505 may include an input module 510, an output module 515, and a multi-tenant operations manager 520. The device 505, or one or more components of the device 505 (e.g., the input module 510, the output module 515, the multi-tenant operations manager 520), may include at least one processor, which may be coupled with at least one memory, to support the described techniques. Each of these components may be in communication with one another (e.g., via one or more buses).

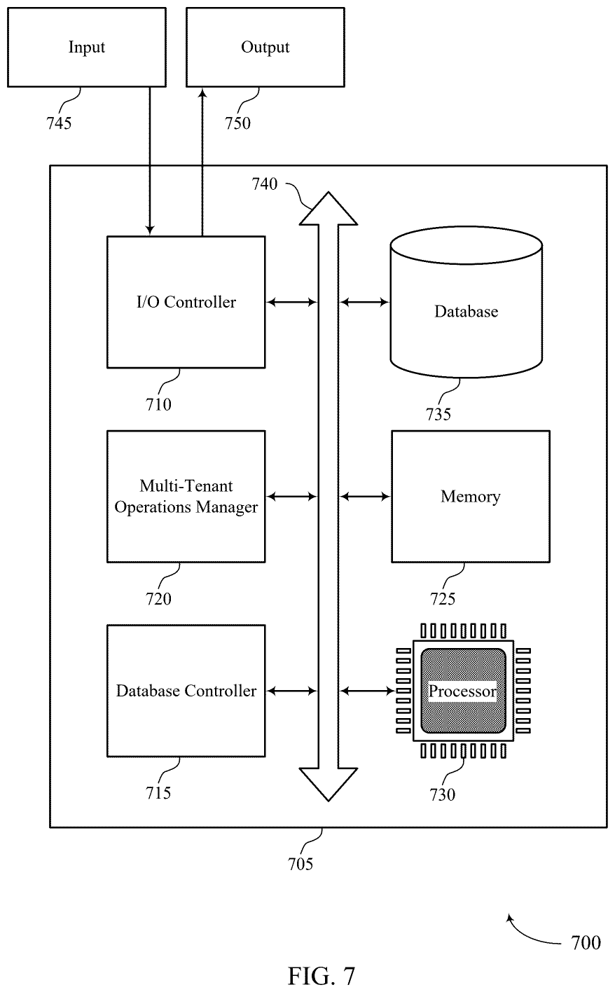

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the multi-tenant operations manager 520 to support multi-tenant generative artificial intelligence system. In some cases, the input module 510 may be a component of an input/output (I/O) controller 710 as described with reference to FIG. 7.

The output module 515 may manage output signals for the device 505. For example, the output module 515 may receive signals from other components of the device 505, such as the multi-tenant operations manager 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the multi-tenant operations manager 520 may include a configuration component 525, a query component 530, a generative AI component 535, a response component 540, or any combination thereof. In some examples, the multi-tenant operations manager 520, or various components thereof, may be configured to perform various operations (e.g., receiving, monitoring, transmitting) using or otherwise in cooperation with the input module 510, the output module 515, or both. For example, the multi-tenant operations manager 520 may receive information from the input module 510, send information to the output module 515, or be integrated in combination with the input module 510, the output module 515, or both to receive information, transmit information, or perform various other operations as described herein.

The multi-tenant operations manager 520 may support data processing in accordance with examples as disclosed herein. The configuration component 525 may be configured to support receiving a configuration associated with a tenant of the multi-tenant generative AI system and tenant-specific training data associated with the tenant, where the configuration includes a first indication of a first communication channel over which a tenant-specific conversational agent is to communicate with users associated with the tenant and where the tenant-specific training data includes context information associated with the tenant that is expressed in natural language. The query component 530 may be configured to support determining an intent of a query received from the tenant based on an analysis of the query. The generative AI component 535 may be configured to support transmitting the query to a first generative AI model of a set of multiple generative AI models, where the first generative AI model is selected based on the determined intent. The response component 540 may be configured to support transmitting, to the tenant over the first communication channel, a response to the query generated by the first generative AI model.

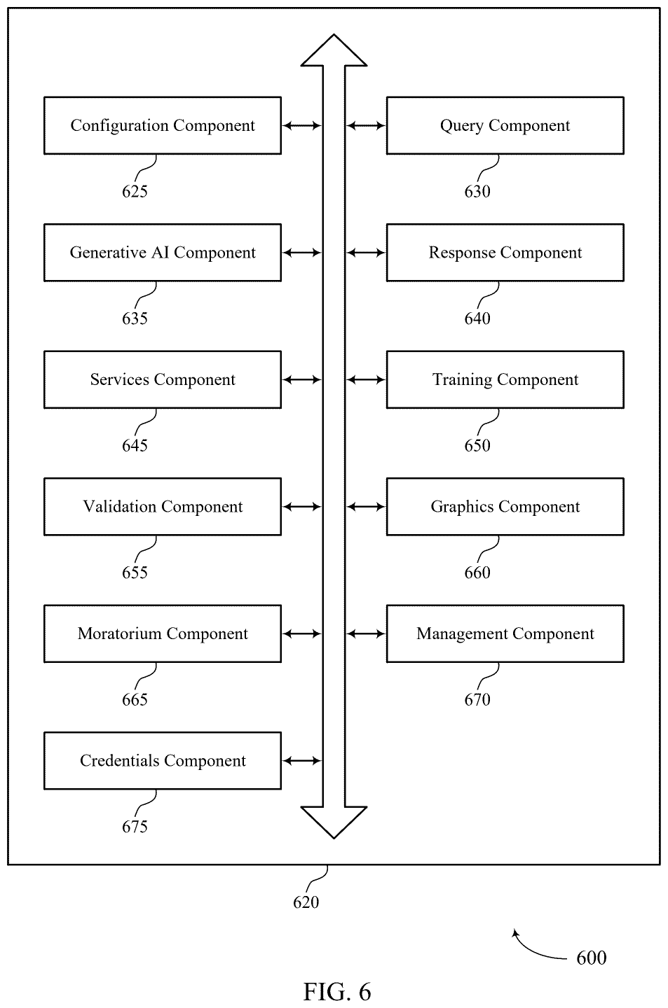

FIG. 6 shows a block diagram 600 of a multi-tenant operations manager 620 that supports multi-tenant generative artificial intelligence system in accordance with examples as disclosed herein. The multi-tenant operations manager 620 may be an example of aspects of a multi-tenant operations manager or a multi-tenant operations manager 520, or both, as described herein. The multi-tenant operations manager 620, or various components thereof, may be an example of means for performing various aspects of multi-tenant generative artificial intelligence system as described herein. For example, the multi-tenant operations manager 620 may include a configuration component 625, a query component 630, a generative AI component 635, a response component 640, a services component 645, a training component 650, a validation component 655, a graphics component 660, a moratorium component 665, a management component 670, a credentials component 675, or any combination thereof. Each of these components, or components of subcomponents thereof (e.g., one or more processors, one or more memories), may communicate, directly or indirectly, with one another (e.g., via one or more buses).

The multi-tenant operations manager 620 may support data processing in accordance with examples as disclosed herein. The configuration component 625 may be configured to support receiving a configuration associated with a tenant of the multi-tenant generative AI system and tenant-specific training data associated with the tenant, where the configuration includes a first indication of a first communication channel over which a tenant-specific conversational agent is to communicate with users associated with the tenant and where the tenant-specific training data includes context information associated with the tenant that is expressed in natural language. The query component 630 may be configured to support determining an intent of a query received from the tenant based on an analysis of the query. The generative AI component 635 may be configured to support transmitting the query to a first generative AI model of a set of multiple generative AI models, where the first generative AI model is selected based on the determined intent. The response component 640 may be configured to support transmitting, to the tenant over the first communication channel, a response to the query generated by the first generative AI model.

In some examples, the services component 645 may be configured to support receiving tenant-specific services data associated with the tenant. In some examples, the services component 645 may be configured to support modifying one or more parameters of one or more elements of the multi-tenant generative AI system based on the tenant-specific services data.

In some examples, the training component 650 may be configured to support parsing the tenant-specific training data to determine the context information, one or more actions that are available to the tenant, one or more conditions associated with the one or more actions, one or more procedures associated with the tenant, one or more services associated with the tenant, or any combination thereof.

In some examples, determining the intent of the query is based on the tenant-specific training data.

In some examples, the services component 645 may be configured to support transmitting, to a service associated with the multi-tenant generative AI system, a request to perform an action indicated in the response to the query. In some examples, the services component 645 may be configured to support receiving, from the service, a first indication that the action has been performed. In some examples, the response component 640 may be configured to support transmitting, to the tenant over the first communication channel, a second indication that the action has been performed.

In some examples, the credentials component 675 may be configured to support requesting one or more credentials from a credential repository based on the response to the query, where the request to perform the action includes an indication of the one or more credentials.

In some examples, the services component 645 may be configured to support selecting the service based on the configuration, the tenant-specific training data, or both.

In some examples, the services component 645 may be configured to support detecting a state of the service based on the configuration, the tenant-specific training data, or both, where the transmission of the request to perform the action is based on the detection of the state.

In some examples, the validation component 655 may be configured to support validating the response to the query via a retrieval augmented generation (RAG) service, an in-context learning (ICL) service, or both, the validation being based on the configuration, the tenant-specific training data, or both.

In some examples, the query component 630 may be configured to support modifying one or more parameters associated with the first generative AI model based on the determined intent.

In some examples, the training component 650 may be configured to support training the first generative AI model based on the tenant-specific training data, an analysis of one or more communications with the tenant-specific conversational agent, one or more previous responses generated by the first generative AI model, or any combination thereof.

In some examples, the query component 630 may be configured to support transmitting, to the tenant over the first communication channel, an indication of a suggested modification to the query based on the analysis of the query, the tenant-specific training data, or both. In some examples, the query component 630 may be configured to support modifying the query based on reception of a response to the indication of the suggested modification to the query.

In some examples, the graphics component 660 may be configured to support presenting, via a user interface, a graphical representation of information indicated in the response to the query, where the graphical representation is presented in a tenant-specific format determined based on the query, the configuration, the tenant-specific training data, or any combination thereof, and where the tenant-specific format is specified in the configuration.

In some examples, the configuration further includes a second indication of a second communication channel associated with escalation operations and a third indication of moratorium information associated with operation of the tenant-specific conversational agent.

In some examples, the moratorium component 665 may be configured to support transmitting an escalation request via the second communication channel based on an escalation indication included in the response to the query.

In some examples, the moratorium component 665 may be configured to support transmitting, to the tenant over the first communication channel and based on satisfaction of a moratorium condition indicated in the moratorium information, an indication of a moratorium period, where the indication of the moratorium period includes a length of the moratorium period, one or more indications of prioritized operations associated with the moratorium period, or any combination thereof.

In some examples, the management component 670 may be configured to support modifying one or more elements of the configuration, the tenant-specific training data, or both, based on reception of one or more modification instructions received via a tenant portal.

In some examples, the management component 670 may be configured to support transmitting, to the tenant over the first communication channel, tenant-specific reporting associated with the tenant and the multi-tenant generative AI system.

In some examples, the generative AI component 635 may be configured to support determining a tenant-specific processing flow that is associated with the tenant and that includes operations associated with the first generative AI model, one or more additional generative AI models of the set of multiple generative AI models, or any combination thereof. In some examples, the query component 630 may be configured to support where transmitting the query to the first generative AI model is based on the tenant-specific processing flow.

FIG. 7 shows a diagram of a system 700 including a device 705 that supports multi-tenant generative artificial intelligence system in accordance with examples as disclosed herein. The device 705 may be an example of or include components of a device 505 as described herein. The device 705 may include components for bi-directional data communications including components for transmitting and receiving communications, such as a multi-tenant operations manager 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting multi-tenant generative artificial intelligence system). The processor 730 may be an example of a single processor or multiple processors. For example, the device 705 may include one or more processors 730.

The multi-tenant operations manager 720 may support data processing in accordance with examples as disclosed herein. For example, the multi-tenant operations manager 720 may be configured to support receiving a configuration associated with a tenant of the multi-tenant generative AI system and tenant-specific training data associated with the tenant, where the configuration includes a first indication of a first communication channel over which a tenant-specific conversational agent is to communicate with users associated with the tenant and where the tenant-specific training data includes context information associated with the tenant that is expressed in natural language. The multi-tenant operations manager 720 may be configured to support determining an intent of a query received from the tenant based on an analysis of the query. The multi-tenant operations manager 720 may be configured to support transmitting the query to a first generative AI model of a set of multiple generative AI models, where the first generative AI model is selected based on the determined intent. The multi-tenant operations manager 720 may be configured to support transmitting, to the tenant over the first communication channel, a response to the query generated by the first generative AI model.

By including or configuring the multi-tenant operations manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

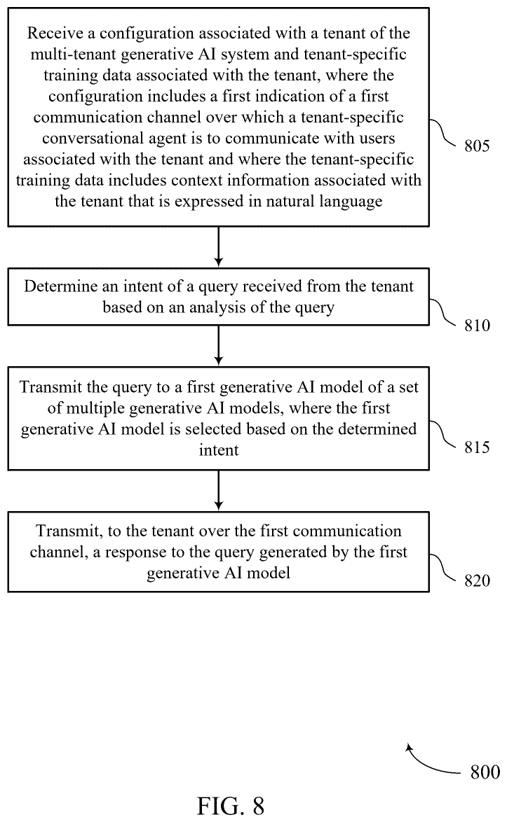

FIG. 8 shows a flowchart illustrating a method 800 that supports multi-tenant generative artificial intelligence system in accordance with examples as disclosed herein. The operations of the method 800 may be implemented by an application server or its components as described herein. For example, the operations of the method 800 may be performed by an application server as described with reference to FIGS. 1 through 7. In some examples, an application server may execute a set of instructions to control the functional elements of the application server to perform the described functions. Additionally, or alternatively, the application server may perform aspects of the described functions using special-purpose hardware.

At 805, the method may include receiving a configuration associated with a tenant of the multi-tenant generative AI system and tenant-specific training data associated with the tenant, where the configuration includes a first indication of a first communication channel over which a tenant-specific conversational agent is to communicate with users associated with the tenant and where the tenant-specific training data includes context information associated with the tenant that is expressed in natural language. The operations of 805 may be performed in accordance with examples as disclosed herein. In some examples, aspects of the operations of 805 may be performed by a configuration component 625 as described with reference to FIG. 6.

At 810, the method may include determining an intent of a query received from the tenant based on an analysis of the query. The operations of 810 may be performed in accordance with examples as disclosed herein. In some examples, aspects of the operations of 810 may be performed by a query component 630 as described with reference to FIG. 6.

At 815, the method may include transmitting the query to a first generative AI model of a set of multiple generative AI models, where the first generative AI model is selected based on the determined intent. The operations of 815 may be performed in accordance with examples as disclosed herein. In some examples, aspects of the operations of 815 may be performed by a generative AI component 635 as described with reference to FIG. 6.

At 820, the method may include transmitting, to the tenant over the first communication channel, a response to the query generated by the first generative AI model. In some examples, the response may be modified before transmitting the response to the tenant. The operations of 820 may be performed in accordance with examples as disclosed herein. In some examples, aspects of the operations of 820 may be performed by a response component 640 as described with reference to FIG. 6.

A method for data processing by a multi-tenant generative artificial intelligence (AI) system is described. The method may include receiving a configuration associated with a tenant of the multi-tenant generative AI system and tenant-specific training data associated with the tenant, where the configuration includes a first indication of a first communication channel over which a tenant-specific conversational agent is to communicate with users associated with the tenant and where the tenant-specific training data includes context information associated with the tenant that is expressed in natural language, determining an intent of a query received from the tenant based on an analysis of the query, transmitting the query to a first generative AI model of a set of multiple generative AI models, where the first generative AI model is selected based on the determined intent, and transmitting, to the tenant over the first communication channel, a response to the query generated by the first generative AI model.

A multi-tenant generative artificial intelligence (AI) system for data processing is described. The multi-tenant generative artificial intelligence (AI) system may include one or more memories storing processor executable code, and one or more processors coupled with the one or more memories. The one or more processors may individually or collectively be operable to execute the code to cause the multi-tenant generative artificial intelligence (AI) system to receive a configuration associated with a tenant of the multi-tenant generative AI system and tenant-specific training data associated with the tenant, where the configuration includes a first indication of a first communication channel over which a tenant-specific conversational agent is to communicate with users associated with the tenant and where the tenant-specific training data includes context information associated with the tenant that is expressed in natural language, determine an intent of a query received from the tenant based on an analysis of the query, transmit the query to a first generative AI model of a set of multiple generative AI models, where the first generative AI model is selected based on the determined intent, and transmit, to the tenant over the first communication channel, a response to the query generated by the first generative AI model.

Another multi-tenant generative artificial intelligence (AI) system for data processing is described. The multi-tenant generative artificial intelligence (AI) system may include means for receiving a configuration associated with a tenant of the multi-tenant generative AI system and tenant-specific training data associated with the tenant, where the configuration includes a first indication of a first communication channel over which a tenant-specific conversational agent is to communicate with users associated with the tenant and where the tenant-specific training data includes context information associated with the tenant that is expressed in natural language, means for determining an intent of a query received from the tenant based on an analysis of the query, means for transmitting the query to a first generative AI model of a set of multiple generative AI models, where the first generative AI model is selected based on the determined intent, and means for transmitting, to the tenant over the first communication channel, a response to the query generated by the first generative AI model.

A non-transitory computer-readable medium storing code for data processing is described. The code may include instructions executable by one or more processors to receive a configuration associated with a tenant of the multi-tenant generative AI system and tenant-specific training data associated with the tenant, where the configuration includes a first indication of a first communication channel over which a tenant-specific conversational agent is to communicate with users associated with the tenant and where the tenant-specific training data includes context information associated with the tenant that is expressed in natural language, determine an intent of a query received from the tenant based on an analysis of the query, transmit the query to a first generative AI model of a set of multiple generative AI models, where the first generative AI model is selected based on the determined intent, and transmit, to the tenant over the first communication channel, a response to the query generated by the first generative AI model.

Some examples of the method, system, and non-transitory computer-readable medium described herein may further include operations, features, means, or instructions for receiving tenant-specific services data associated with the tenant and modifying one or more parameters of one or more elements of the multi-tenant generative AI system based on the tenant-specific services data.

Some examples of the method, system, and non-transitory computer-readable medium described herein may further include operations, features, means, or instructions for parsing the tenant-specific training data to determine the context information, one or more actions that may be available to the tenant, one or more conditions associated with the one or more actions, one or more procedures associated with the tenant, one or more services associated with the tenant, or any combination thereof.

Some examples of the method, system, and non-transitory computer-readable medium described herein may further include operations, features, means, or instructions for determining the intent of the query may be based on the tenant-specific training data.

Some examples of the method, system, and non-transitory computer-readable medium described herein may further include operations, features, means, or instructions for transmitting, to a service associated with the multi-tenant generative AI system, a request to perform an action indicated in the response to the query, receiving, from the service, a first indication that the action may have been performed, and transmitting, to the tenant over the first communication channel, a second indication that the action may have been performed.

Some examples of the method, system, and non-transitory computer-readable medium described herein may further include operations, features, means, or instructions for requesting one or more credentials from a credential repository based on the response to the query, where the request to perform the action includes an indication of the one or more credentials.

Some examples of the method, system, and non-transitory computer-readable medium described herein may further include operations, features, means, or instructions for selecting the service based on the configuration, the tenant-specific training data, or both.

Some examples of the method, system, and non-transitory computer-readable medium described herein may further include operations, features, means, or instructions for detecting a state of the service based on the configuration, the tenant-specific training data, or both, where the transmission of the request to perform the action may be based on the detection of the state.

Some examples of the method, system, and non-transitory computer-readable medium described herein may further include operations, features, means, or instructions for validating the response to the query via a retrieval augmented generation (RAG) service, an in-context learning (ICL) service, or both, the validation being based on the configuration, the tenant-specific training data, or both.

Some examples of the method, system, and non-transitory computer-readable medium described herein may further include operations, features, means, or instructions for modifying one or more parameters associated with the first generative AI model based on the determined intent.

Some examples of the method, system, and non-transitory computer-readable medium described herein may further include operations, features, means, or instructions for training the first generative AI model based on the tenant-specific training data, an analysis of one or more communications with the tenant-specific conversational agent, one or more previous responses generated by the first generative AI model, or any combination thereof.

Some examples of the method, system, and non-transitory computer-readable medium described herein may further include operations, features, means, or instructions for transmitting, to the tenant over the first communication channel, an indication of a suggested modification to the query based on the analysis of the query, the tenant-specific training data, or both and modifying the query based on reception of a response to the indication of the suggested modification to the query.

Some examples of the method, system, and non-transitory computer-readable medium described herein may further include operations, features, means, or instructions for presenting, via a user interface, a graphical representation of information indicated in the response to the query, where the graphical representation may be presented in a tenant-specific format determined based on the query, the configuration, the tenant-specific training data, or any combination thereof, and where the tenant-specific format may be specified in the configuration.

In some examples of the method, system, and non-transitory computer-readable medium described herein, the configuration further includes a second indication of a second communication channel associated with escalation operations and a third indication of moratorium information associated with operation of the tenant-specific conversational agent.

Some examples of the method, system, and non-transitory computer-readable medium described herein may further include operations, features, means, or instructions for transmitting an escalation request via the second communication channel based on an escalation indication included in the response to the query.

Some examples of the method, system, and non-transitory computer-readable medium described herein may further include operations, features, means, or instructions for transmitting, to the tenant over the first communication channel and based on satisfaction of a moratorium condition indicated in the moratorium information, an indication of a moratorium period, where the indication of the moratorium period includes a length of the moratorium period, one or more indications of prioritized operations associated with the moratorium period, or any combination thereof.

Some examples of the method, system, and non-transitory computer-readable medium described herein may further include operations, features, means, or instructions for modifying one or more elements of the configuration, the tenant-specific training data, or both, based on reception of one or more modification instructions received via a tenant portal.

Some examples of the method, system, and non-transitory computer-readable medium described herein may further include operations, features, means, or instructions for transmitting, to the tenant over the first communication channel, tenant-specific reporting associated with the tenant and the multi-tenant generative AI system.

Some examples of the method, system, and non-transitory computer-readable medium described herein may further include operations, features, means, or instructions for determining a tenant-specific processing flow that may be associated with the tenant and that includes operations associated with the first generative AI model, one or more additional generative AI models of the set of multiple generative AI models, or any combination thereof and where transmitting the query to the first generative AI model may be based on the tenant-specific processing flow.

The following provides an overview of aspects of the present disclosure:
Aspect 1: A method for data processing at a multi-tenant generative artificial intelligence (AI) system, comprising: receiving a configuration associated with a tenant of the multi-tenant generative AI system and tenant-specific training data associated with the tenant, wherein the configuration includes a first indication of a first communication channel over which a tenant-specific conversational agent is to communicate with users associated with the tenant and wherein the tenant-specific training data includes context information associated with the tenant that is expressed in natural language; determining an intent of a query received from the tenant based at least in part on an analysis of the query; transmitting the query to a first generative AI model of a plurality of generative AI models, wherein the first generative AI model is selected based at least in part on the determined intent; and transmitting, to the tenant over the first communication channel, a response to the query generated by the first generative AI model.
Aspect 2: The method of aspect 1, further comprising: receiving tenant-specific services data associated with the tenant; and modifying one or more parameters of one or more elements of the multi-tenant generative AI system based at least in part on the tenant-specific services data.
Aspect 3: The method of any of aspects 1 through 2, further comprising: parsing the tenant-specific training data to determine the context information, one or more actions that are available to the tenant, one or more conditions associated with the one or more actions, one or more procedures associated with the tenant, one or more services associated with the tenant, or any combination thereof.
Aspect 4: The method of any of aspects 1 through 3, wherein determining the intent of the query is based at least in part on the tenant-specific training data.
Aspect 5: The method of any of aspects 1 through 4, further comprising: transmitting, to a service associated with the multi-tenant generative AI system, a request to perform an action indicated in the response to the query; receiving, from the service, a first indication that the action has been performed; and transmitting, to the tenant over the first communication channel, a second indication that the action has been performed.
Aspect 6: The method of aspect 5, further comprising: requesting one or more credentials from a credential repository based at least in part on the response to the query, wherein the request to perform the action comprises an indication of the one or more credentials.
Aspect 7: The method of any of aspects 5 through 6, further comprising: selecting the service based at least in part on the configuration, the tenant-specific training data, or both.
Aspect 8: The method of any of aspects 5 through 7, further comprising: detecting a state of the service based at least in part on the configuration, the tenant-specific training data, or both, wherein the transmission of the request to perform the action is based at least in part on the detection of the state.
Aspect 9: The method of any of aspects 1 through 8, further comprising: validating the response to the query via a retrieval augmented generation (RAG) service, an in-context learning (ICL) service, or both, the validation being based at least in part on the configuration, the tenant-specific training data, or both.
Aspect 10: The method of any of aspects 1 through 9, further comprising: modifying one or more parameters associated with the first generative AI model based at least in part on the determined intent.
Aspect 11: The method of any of aspects 1 through 10, further comprising: training the first generative AI model based at least in part on the tenant-specific training data, an analysis of one or more communications with the tenant-specific conversational agent, one or more previous responses generated by the first generative AI model, or any combination thereof.
Aspect 12: The method of any of aspects 1 through 11, further comprising: transmitting, to the tenant over the first communication channel, an indication of a suggested modification to the query based at least in part on the analysis of the query, the tenant-specific training data, or both; and modifying the query based at least in part on reception of a response to the indication of the suggested modification to the query.
Aspect 13: The method of any of aspects 1 through 12, further comprising: presenting, via a user interface, a graphical representation of information indicated in the response to the query, wherein the graphical representation is presented in a tenant-specific format determined based at least in part on the query, the configuration, the tenant-specific training data, or any combination thereof, and wherein the tenant-specific format is specified in the configuration.
Aspect 14: The method of any of aspects 1 through 13, wherein the configuration further includes a second indication of a second communication channel associated with escalation operations and a third indication of moratorium information associated with operation of the tenant-specific conversational agent.
Aspect 15: The method of aspect 14, further comprising: transmitting an escalation request via the second communication channel based at least in part on an escalation indication comprised in the response to the query.
Aspect 16: The method of any of aspects 14 through 15, further comprising: transmitting, to the tenant over the first communication channel and based at least in part on satisfaction of a moratorium condition indicated in the moratorium information, an indication of a moratorium period, wherein the indication of the moratorium period comprises a length of the moratorium period, one or more indications of prioritized operations associated with the moratorium period, or any combination thereof.
Aspect 17: The method of any of aspects 1 through 16, further comprising: modifying one or more elements of the configuration, the tenant-specific training data, or both, based at least in part on reception of one or more modification instructions received via a tenant portal.
Aspect 18: The method of any of aspects 1 through 17, further comprising: transmitting, to the tenant over the first communication channel, tenant-specific reporting associated with the tenant and the multi-tenant generative AI system.
Aspect 19: The method of any of aspects 1 through 18, further comprising: determining a tenant-specific processing flow that is associated with the tenant and that comprises operations associated with the first generative AI model, one or more additional generative AI models of the plurality of generative AI models, or any combination thereof; wherein transmitting the query to the first generative AI model is based at least in part on the tenant-specific processing flow.
Aspect 20: A multi-tenant generative artificial intelligence (AI) system for data processing, comprising one or more memories storing processor-executable code, and one or more processors coupled with the one or more memories and individually or collectively operable to execute the code to cause the multi-tenant generative artificial intelligence (AI) system to perform a method of any of aspects 1 through 19.
Aspect 21: A multi-tenant generative artificial intelligence (AI) system for data processing, comprising at least one means for performing a method of any of aspects 1 through 19.
Aspect 22: A non-transitory computer-readable medium storing code for data processing, the code comprising instructions executable by one or more processors to perform a method of any of aspects 1 through 19.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing at a multi-tenant generative artificial intelligence (AI) system, comprising:
receiving a configuration associated with a tenant of the multi-tenant generative AI system and tenant-specific training data associated with the tenant, wherein the configuration includes a first indication of a first communication channel over which a tenant-specific conversational agent is to communicate with users associated with the tenant and wherein the tenant-specific training data includes context information associated with the tenant that is expressed in natural language;
determining an intent of a query received from the tenant based at least in part on an analysis of the query;
transmitting the query to a first generative AI model of a plurality of generative AI models, wherein the first generative AI model is selected based at least in part on the determined intent; and
transmitting, to the tenant over the first communication channel, a response to the query generated by the first generative AI model.

2. The method of claim 1, further comprising:
receiving tenant-specific services data associated with the tenant; and
modifying one or more parameters of one or more elements of the multi-tenant generative AI system based at least in part on the tenant-specific services data.

3. The method of claim 1, further comprising:
parsing the tenant-specific training data to determine the context information, one or more actions that are available to the tenant, one or more conditions associated with the one or more actions, one or more procedures associated with the tenant, one or more services associated with the tenant, or any combination thereof.

4. The method of claim 1, wherein determining the intent of the query is based at least in part on the tenant-specific training data.

5. The method of claim 1, further comprising:
transmitting, to a service associated with the multi-tenant generative AI system, a request to perform an action indicated in the response to the query;
receiving, from the service, a first indication that the action has been performed; and
transmitting, to the tenant over the first communication channel, a second indication that the action has been performed.

6. The method of claim 5, further comprising:
requesting one or more credentials from a credential repository based at least in part on the response to the query, wherein the request to perform the action comprises an indication of the one or more credentials.

7. The method of claim 5, further comprising:
selecting the service based at least in part on the configuration, the tenant-specific training data, or both.

8. The method of claim 5, further comprising:
detecting a state of the service based at least in part on the configuration, the tenant-specific training data, or both, wherein the transmission of the request to perform the action is based at least in part on the detection of the state.

9. The method of claim 1, further comprising:
validating the response to the query via a retrieval augmented generation (RAG) service, or an in-context learning (ICL) service, or both, the validation being based at least in part on the configuration, the tenant-specific training data, or both.

10. The method of claim 1, further comprising:
modifying one or more parameters associated with the first generative AI model based at least in part on the determined intent.

11. The method of claim 1, further comprising:
training the first generative AI model based at least in part on the tenant-specific training data, an analysis of one or more communications with the tenant-specific conversational agent, one or more previous responses generated by the first generative AI model, or any combination thereof.

12. The method of claim 1, further comprising:
transmitting, to the tenant over the first communication channel, an indication of a suggested modification to the query based at least in part on the analysis of the query, the tenant-specific training data, or both; and
modifying the query based at least in part on reception of a response to the indication of the suggested modification to the query.

13. The method of claim 1, further comprising:
presenting, via a user interface, a graphical representation of information indicated in the response to the query, wherein the graphical representation is presented in a tenant-specific format determined based at least in part on the query, the configuration, the tenant-specific training data, or any combination thereof, and wherein the tenant-specific format is specified in the configuration.

14. The method of claim 1, wherein the configuration further includes a second indication of a second communication channel associated with escalation operations and a third indication of moratorium information associated with operation of the tenant- specific conversational agent.

15. The method of claim 14, further comprising:
transmitting an escalation request via the second communication channel based at least in part on an escalation indication comprised in the response to the query.

16. The method of claim 14, further comprising:
transmitting, to the tenant over the first communication channel and based at least in part on satisfaction of a moratorium condition indicated in the moratorium information, an indication of a moratorium period, wherein the indication of the moratorium period comprises a length of the moratorium period, one or more indications of prioritized operations associated with the moratorium period, or any combination thereof.

17. The method of claim 1, further comprising:
modifying one or more elements of the configuration, the tenant-specific training data, or both, based at least in part on reception of one or more modification instructions received via a tenant portal.

18. The method of claim 1, further comprising:
transmitting, to the tenant over the first communication channel, tenant-specific reporting associated with the tenant and the multi-tenant generative AI system.

19. The method of claim 1, further comprising:
determining a tenant-specific processing flow that is associated with the tenant and that comprises operations associated with the first generative AI model, one or more additional generative AI models of the plurality of generative AI models, or any combination thereof;
wherein transmitting the query to the first generative AI model is based at least in part on the tenant-specific processing flow.

20. A multi-tenant generative artificial intelligence (AI) system for data processing, comprising:
one or more memories storing processor-executable code; and
one or more processors coupled with the one or more memories and individually or collectively operable to execute the code to cause the multi-tenant generative artificial intelligence (AI) system to:
receive a configuration associated with a tenant of the multi-tenant generative AI system and tenant-specific training data associated with the tenant, wherein the configuration includes a first indication of a first communication channel over which a tenant-specific conversational agent is to communicate with users associated with the tenant and wherein the tenant-specific training data includes context information associated with the tenant that is expressed in natural language;
determine an intent of a query received from the tenant based at least in part on an analysis of the query;
transmit the query to a first generative AI model of a plurality of generative AI models, wherein the first generative AI model is selected based at least in part on the determined intent; and
transmit, to the tenant over the first communication channel, a response to the query generated by the first generative AI model.
